(19) United States
(12) Patent Application Publication
(10) Pub. No.: US 2026/0288549 A1
(43) Pub. Date: Sep. 24, 2026

(54) SYSTEM AND METHOD FOR SYNCHRONIZATION OF COLLABORATIVELY EDITED CONTENT SECTIONS

(71) Applicant: Atticus, LLC, Franklin, TN (US)

(72) Inventors: Roy David Chesson, Franklin, TN (US); Henry Marcacci, Franklin, TN (US); Jenna Coleman, Franklin, TN (US)

(21) Appl. No.: 19/083,411

(22) Filed: Mar. 18, 2025

(51) Int. Cl. G06F 9/54; H04L 67/02

(52) U.S. Cl. CPC G06F 9/547; H04L 67/02

(57) ABSTRACT

A system and method are provided for synchronizing replicas of collaborative data entities across multiple client devices, wherein each replica comprises shared content having multiple sections in a defined arrangement. Each client generates, for each section, a corresponding representation of the content including any edits thereto, and transmits an encoded first state of each representation for the respective client to a central device (e.g., host server) via web service (e.g., HTTP) calls. The central device, for each corresponding representation: calculates a first state vector from the encoded first state; calculates a second state vector corresponding to a second state of the representation; determines missing updates for any given device based on the calculated state vectors; applies any relevant updates to the representation for the central device; and responds via the same HTTP call with any relevant updates for the respective client, which applies the relevant updates to the corresponding representation.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### BACKGROUND

The present invention relates generally to synchronization of content in a distributed computing environment. More particularly, an embodiment of an invention as disclosed herein relates to systems and methods which synchronize edited sections (e.g., chapters) of an aggregated content unit (e.g., book) in a distributed and collaborative computing environment with a single web service call, for example using the Hypertext Transfer Protocol (HTTP).

Conventional examples of collaborative computing environments may typically include cloud platforms linking one or more host servers with a number of client users in a distributed fashion. Such environments may allow users to collaborate to create, edit, or otherwise produce content such as, e.g., textual works having a large number of sections (e.g., chapters). In many such environments, users may comment upon the text and provide edits of their own, while also reviewing comments and edits from other users substantially in real time.

Document editing environments may incorporate or otherwise enable the use of tools such as rich text editors, which in many examples are text editors that can be embedded in a browser along with many custom and default plugins to allow authors to manipulate chapter content. However, the chapter content synchronization logic associated with conventional rich text editors do not effectively support collaborative editing. Edits made to a chapter may be shared across multiple clients through a two-way interactive communication session, for example a WebSocket connection, in the form of plate operations, but without conflict resolution logic implemented to handle collaborative editing. The edits made by each client in this context may simply be queued within the client itself and fed into the WebSocket connection.

In an example as is presently known in the art, a WebSocket API (Application Program Interface) in API Gateway may enable persistent, bidirectional interactions and further include Lambda functions attached to handle WebSocket events. However, the current implementation does not include or otherwise provide a way to maintain WebSocket server state (connections) when scaling.

As one known approach to support collaborative editing, a Yjs-based sync method is provided for advanced conflict resolution, presence and awareness, and better scaling, in the context of a conflict-free replicated data type (CRDT) implementation. Yjs is network agnostic but depends on ‘shared types’to share content across multiple clients while resolving conflicts. Shared types are similar to common data types like strings, arrays, and maps, but have much functionality built on them to support seamless merging and collaboration. Shared types are defined within a Yjs document (Ydoc) and a single Ydoc can have multiple shared types defined within. Ydocs are ephemeral and they are not stored in any persisted storage, but rather they are constructed in-memory on the fly by assembling ‘edits’.

Yjs may be characterized as prioritizing the representation of edits, for example in contrast to the document as a whole, and a Ydoc as a representation of the edits in a way that a rich text editor or any other consumer can render and modify the same. The edits may be stored in persistent storage as a sequence of updates, for example in the Uint8Array format.

One problem with the above-referenced approach is that synchronizing updates and/or edits between a client and a server is usually a two-step process which occurs, e.g., over a WebSocket connection. These two steps may for example be defined as sync-step-1 and sync-step-2 in y-protocols. There are presently numerous use cases where programmatic synchronizing of all chapters of all books in a defined batch is required, such as for example an initial book load and export process, and wherein the standard WebSocket event-based sync approach is unsuitable for programmatically syncing hundreds of chapters due to performance constraints and reliability issues.

### BRIEF SUMMARY

The current disclosure provides an enhancement to conventional systems, at least in part by introducing a novel HTTP-based sync approach, which achieves an equivalent of the desired outcome (e.g., via the standard sync-step-1 and sync-step-2) in one HTTP call.

Various embodiments of such an approach as disclosed herein may for example achieve the same output as the standard sync procedure, without having to load the chapter content in a plate editor instance, without having to establish a WebSocket connection, and having to rely on WebSocket events. This may allow a large number of chapters to be properly synchronized concurrently, which makes the entire sync process faster, less resource consuming, and more reliable.

In one exemplary embodiment as disclosed herein, a method is provided for synchronizing replicas of collaborative data entities across a plurality of computing devices, wherein each replica comprises shared content having a plurality of sections in a defined arrangement. The method includes generating, for each of the plurality of sections, a corresponding representation of the respective content including any edits thereto. For each of the corresponding representations, the method further includes encoding an entire first state of the representation for a first computing device of the plurality of computing devices, and transmitting the encoded state of the representation for the first computing device from the first computing device to a second computing device via a first web service call. At the second computing device, a first state vector is calculated from the encoded first state, a second state vector is calculated as corresponding to a second state of the representation for the second computing device, any missing updates are determined with respect to the first computing device and/or the second computing device based on at least the calculated first and second state vectors, and any relevant updates are applied to the representation for the second computing device. In association with the first web service call, any relevant updates with respect to the first computing device are provided from the second computing device, wherein the any relevant updates with respect to the first computing device are applied to the representation for the first computing device.

In further exemplary and optional aspects according to the above-referenced method embodiment, a first hash digest of the representation for the first computing device may be generated. Upon applying the relevant updates to the representation for the second computing device, a second hash digest of the representation for the second computing device may be generated and transmitted to the first computing device as part of the response to the web service call. The first hash digest and the second hash digest may be compared at the first computing device, wherein upon determining that the first hash digest and the second hash digest are not synchronized, the any relevant updates may be applied with respect to the first computing device.

In another exemplary and optional aspect according to the above-referenced method embodiment, the web service call is executed using the HTTP protocol.

In another exemplary and optional aspect according to the above-referenced method embodiment, each of the plurality of sections may correspond to a chapter in a defined book arrangement.

In another exemplary and optional aspect according to the above-referenced method embodiment, concurrent synchronization of each chapter in the defined book arrangement may be programmatically executed in association with a requested import or export event.

In another exemplary and optional aspect according to the above-referenced method embodiment, each representation may comprise a respective conflict-free replicated data type (CRDT) file.

In another exemplary and optional aspect according to the above-referenced method embodiment, the first computing device may be a client and the second computing device may be a server.

In another exemplary and optional aspect according to the above-referenced method embodiment, the server may independently carry out associated steps in the method with respect to web service calls to and from each of a plurality of first computing devices.

In another embodiment as disclosed herein, a system is provided for synchronizing replicas of collaborative data entities across a plurality of client computing devices, wherein each replica comprises shared content having a plurality of sections in a defined arrangement, each of the plurality of sections having a corresponding representation of edits to content there within. A central computing device is functionally linkable to each of the plurality of client computing devices via a communications network. Each of the client computing devices is configured to: generate, for each of the plurality of sections, a corresponding representation of the respective content including any edits thereto; and for each of the corresponding representations, encode an entire first state of the representation for the respective client computing device and further transmit the encoded state of the representation for the respective client computing device to the central computing device via a web service call. The central computing device is configured, for each of the corresponding representations, to: calculate a first state vector from the encoded first state; calculate a second state vector corresponding to a second state of the representation for the central computing device; determine any missing updates with respect to the respective client computing device and/or the central computing device based on at least the calculated first and second state vectors; apply any relevant updates to the representation for the central computing device; and generate a response to the web service call to the respective client computing device, the response comprising any relevant updates for the respective client computing device. The respective client computing device is further configured to apply the any relevant updates for the respective client computing device to the corresponding representation for the respective client computing device.

In further exemplary and optional aspects according to the above-referenced system embodiment, for each of the corresponding representations: the respective client computing device may be configured to generate a first hash digest of the representation for the respective client computing device; the central computing device may be configured, upon applying the any relevant updates to the representation for the central computing device, to generate a second hash digest of the representation for the central computing device, and transmit the second hash digest to the respective client computing device as part of the response to the web service call; and the respective client computing device may be further configured to compare the first hash digest and the second hash digest, and upon determining that the first hash digest and the second hash digest are not synchronized, apply the any relevant updates.

Numerous objects, features and advantages of the embodiments set forth herein will be readily apparent to those skilled in the art upon reading of the following disclosure when taken in conjunction with the accompanying drawings.

### BRIEF DESCRIPTION OF THE SEVERAL VIEWS OF THE DRAWINGS

FIG. 1 is a graphical diagram representing a simplified embodiment of a collaborative system as disclosed herein.

FIG. 2 is a flowchart representing an embodiment of a method as disclosed herein.

FIG. 3 is a flowchart representing another embodiment of a method as disclosed herein.

FIG. 4 is a graphical diagram representing another embodiment of a system and method as disclosed herein.

### DETAILED DESCRIPTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention. The implementations disclosed in the above drawings and the following detailed description are not intended to be exhaustive or to limit the present disclosure to these implementations. Any alterations and further modifications to the described devices, systems, methods, and any further application of the principles of the present disclosure are fully contemplated as would normally occur to one skilled in the art to which the disclosure relates. In particular, it is fully contemplated that the features, components, steps, or a combination thereof described with respect to one example may be combined with the features, components, steps, or a combination thereof described with respect to other examples of the present disclosure.

The present disclosure is intended to cover such modifications and variations as come within the scope of the appended claims and their equivalents. Other objects, features, and aspects of the present disclosure are disclosed in the following detailed description. One of skill in the art will understand that the present discussion is a description of exemplary embodiments only and is not intended as limiting the broader aspects of the present disclosure.

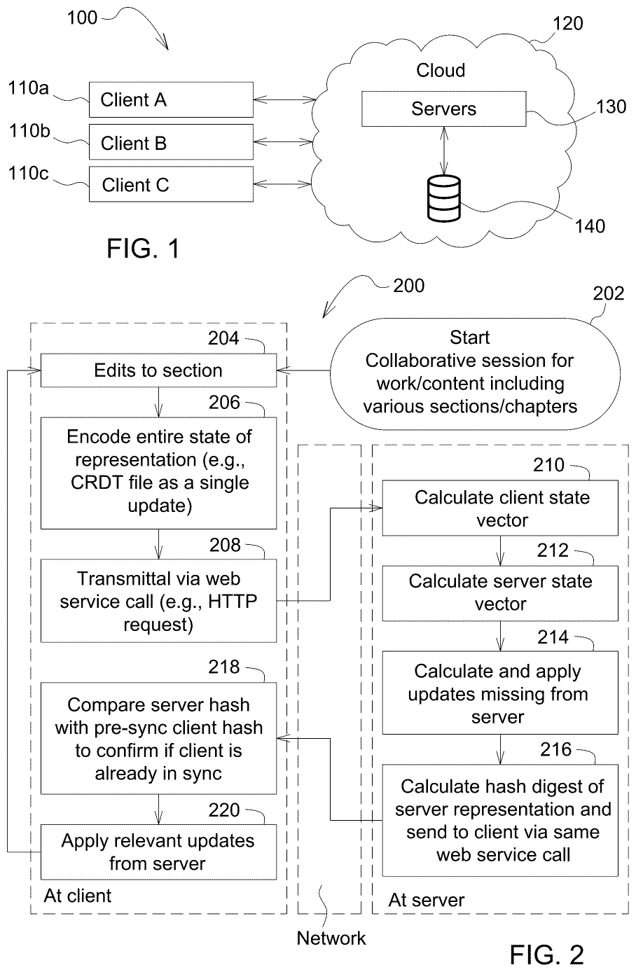

FIG. 1 illustrates a simplified block diagram of an exemplary embodiment of a collaborative system 100 and associated network infrastructure according to aspects of the present disclosure. The system 100 as shown includes various clients 110 in the context for example of respective users, computing devices, or the like, and referenced as client A, client B, and client C (numerically labeled as 110a, 110b, 110c, respectively). The system 100 as shown further includes a cloud network 120, including for example a network interface, by which the various clients 110 may be communicatively coupled to and otherwise access applications and/or data via one or more servers 130, and wherein users associated with any of the respective clients 110a, 110b, 110c may comment on, edit, or otherwise interact with collaborative content. The aforementioned components may be connected or otherwise functionally linked via a communications network which in various embodiments may include, in whole or in part, the Internet, a public network, a private network, or any other communications medium capable of conveying electronic communications.

In various exemplary embodiments, any or all of the computing devices associated with clients 110 or servers 130 may be implemented as at least one of a server computer, a server device, a desktop computer, a laptop computer, a smart phone, or any other electronic device capable of executing instructions. A processor (such as a microprocessor) of the computing devices may be a generic hardware processor, a special-purpose hardware processor, or a combination thereof. In embodiments having a generic hardware processor (e.g., as a central processing unit (CPU) available from manufacturers such as Intel and/or AMD), the generic hardware processor may be configured to be converted to a special-purpose processor by means of being programmed to execute and/or by executing a particular program, algorithm, or the like in a manner discussed herein for providing a specific operation or result.

The host servers 130 may be functionally linked to data storage 140 configured to store sets of information and/or metadata usable by the system 100 to perform or assist in performing one or more operations or functionality described herein. One or more of the clients 110 may likewise include or otherwise be functionally linked to data storage (not shown) independent of data storage for the servers or the other clients. The servers 130 may accordingly be configured to operate remotely and may be configured to obtain or otherwise operate upon one or more instructions stored physically remote from each of the clients 110 (e.g., via client-server communications and/or cloud-based computing).

It should be noted that whereas one server 130 and three clients 110 are illustrated in FIG. 1, this is not in any way a limitation on the scope of a system 100 as disclosed herein, and one of skill in the art may readily appreciate that the respective numbers of clients and servers may be substantially higher than illustrated, at least in accordance with improved scaling as allowed by a system as disclosed herein.

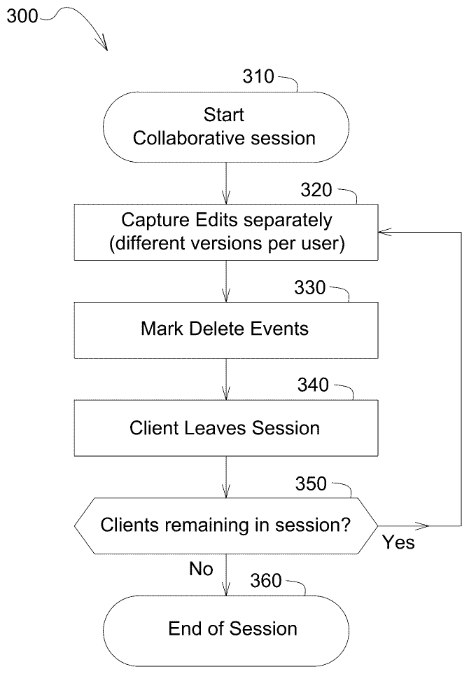

Referring next to FIG. 2, an exemplary embodiment of a method 200 may now be described, which begins in step 202 upon starting a collaborative session with respect to a number of collaborative data entities across a number of client devices. Such data entities may be referred to herein as documents, for example in the context of work or content including various sections in a defined arrangement, such as for example chapters in a book. In addition, and unless otherwise specifically noted herein, steps of the method 200 as described herein with respect to a particular “client” may be understood as potentially being performed by any of one or more clients able to access the same document, and steps of the method 200 as described herein with respect to a particular “server” may likewise be understood as potentially being performed by any of one or more servers in a cloud network, for example associated with a host document editing platform.

Depending on the embodiment, certain acts, events, or functions of any of the steps described herein can be performed in a different sequence, can be added, merged, or left out altogether (e.g., not all described acts or events are necessary for the practice of the step). In an embodiment as discussed below, the method 200 may be performed by system components as described above by further reference to FIG. 1. However, the scope of the method 200 is not intended as being structurally limited to this configuration unless otherwise specifically noted.

According to the method 200, each user associated with a collaborative session may in step 204, and via a respective client device, account, etc., provide edits to one or more sections of the document. The term “edits” as used herein may for example refer to or otherwise encompass any changes or updates, including but not limited to additions, deletions, comments, and/or the like. In some embodiments, an edit may be more narrowly defined as either additions (insertions) or deletions, without encompassing comments or other changes with respect to the previous document structure. Each respective client accordingly generates, for each of the edited plurality of sections, a corresponding representation of the respective content including any edits thereto. In an embodiment, each section (e.g., chapter) may be represented by a single CRDT file (e.g., a Ydoc in the context of a Yjs framework as noted above and further described herein for illustrative purposes).

The method 200 may continue, for each of the corresponding representations, in step 206 by encoding an entire first state of the respective representation as a single update (e.g., Uint8Array encoded as a base64 string) and transmittal of encoded state from the client to the server via web service call (e.g., as an HTTP request) in step 208. In various embodiments, it may be appreciated that a current state of the document at the respective client (i.e., “first state” in the context of the illustrated step) may be constructed ad hoc as a compilation of edits and is not persistently stored at the client level as part of the recited steps herein.

At the server level, the illustrated embodiment of a method 200 continues in step 210 by calculating a client state vector from the encoded client state. As used herein, a state vector may be defined according to a mapped or otherwise identified sequence of blocks or document structures having corresponding edits (e.g., insertions or deletions) and time values. State vectors according to the present disclosure are not used to track causality, but typically to describe the state of the respective document, wherein calculation of the missing structure for a remote client may be calculated at the server level.

The method 200 may further continue at the server level in step 212 with calculating of a second state vector corresponding to a second state of the representation (e.g., Ydoc) for the server itself. For example, the entire state of the server Ydoc may be retrieved as a single update, and the server state vector may be calculated therefrom.

The method 200 continues at the server level in step 214 with calculating or otherwise determining any updates missing from the client and the server, using the previously calculated client/server states and state vectors. Any updates missing from the server are then applied on the server representation (e.g., Ydoc) and accordingly stored in data storage functionally linked to the server (e.g., in a document-oriented database product such as MongoDB).

Once the updates are applied, a hash digest of the server representation is calculated for transmittal in step 216 back to the client, preferably with respect to the same web service call (e.g., the HTTP response). The hash digest may then be used by the client in step 218 to compare with the pre-sync hash of the client representation, for example to check whether client is already in sync with the server, before applying any relevant updates from the server in step 220.

One of skill in the art may appreciate this approach achieves an equivalent output as the standard synchronization procedure, without having to load the chapter content in a plate editor instance, without having to establish a WebSocket connection, and without having to rely on WebSocket events. A large number of chapters may accordingly be synced concurrently, with the desirable result of making the entire synchronization process faster, less resource consuming, and more reliable.

Referring next to FIG. 3, an embodiment of a method 300 may next be described for collaborative document editing by integrating automatic session management, granular version tracking, dynamic document update workflows, and comprehensive version retrieval. In various embodiments, document versioning may be implemented in accordance with the method 300 for enhancing traceability and accountability with collaborative editing, allowing users to easily identify when and what content was updated and removed.

The referenced methods 200, 300 may be completely separate, or in some embodiments may be performed together and with respect to the same client-server system 100. As with method 200, depending on the embodiment, certain acts, events, or functions of any of the steps described herein with respect to the method 300 can be performed in a different sequence, can be added, merged, or left out altogether, and the scope of the method 300, while capable of performance by a system as illustrated in FIG. 1, is not intended as being structurally limited to this configuration unless otherwise specifically noted.

The illustrated method 300 begins with collaborative session initiation in step 310. A session is created whenever one or more users, for example via respective client devices, join a collaborative work (e.g., whole document or chapter).

The method 300 further includes version tracking in step 320, wherein edits by each respective user are captured separately and in different versions of the collaborative work. Each version may for example include or otherwise represent a set of specific changes made to the work within a given session, as well as an identifier (user ID) associated with the individual making the changes. In one example, wherein a session has been initiated by a first user (User A), several edits made to the work may be captured in versions and transmitted at fixed durations (e.g., every five seconds) while the first user is idle.

The method 300 may further include handling of delete events in step 330. Delete events may be specific versions that are generated to record the deletion of content. For example, if user A as referenced above deletes a section of the document, and this is their last activity before the version is transmitted and before the creation of a new version, this action may be marked as a delete event in the version record.

As noted above, the method 300 contemplates session continuation, wherein more than one user joins the same document (e.g., first user A initiates the session and is subsequently joined during the same session, with respect to the same document, by user B), thereby continuing the session. Steps 320 and 330 may be performed concurrently for each user, wherein for example the changes made by both of user A and user B are recorded separately.

When a user leaves the document in step 340, and at least one other user remains in the session (i.e., “yes” in reply to the query in step 350), the method 300 returns to steps 320, 330 and the session continues with the remaining users, along with the corresponding version tracking and handling of delete events.

When a user leaves the document in step 340, and no other user remains in the session (i.e., “no” in reply to the query in step 350), the session ends in step 360.

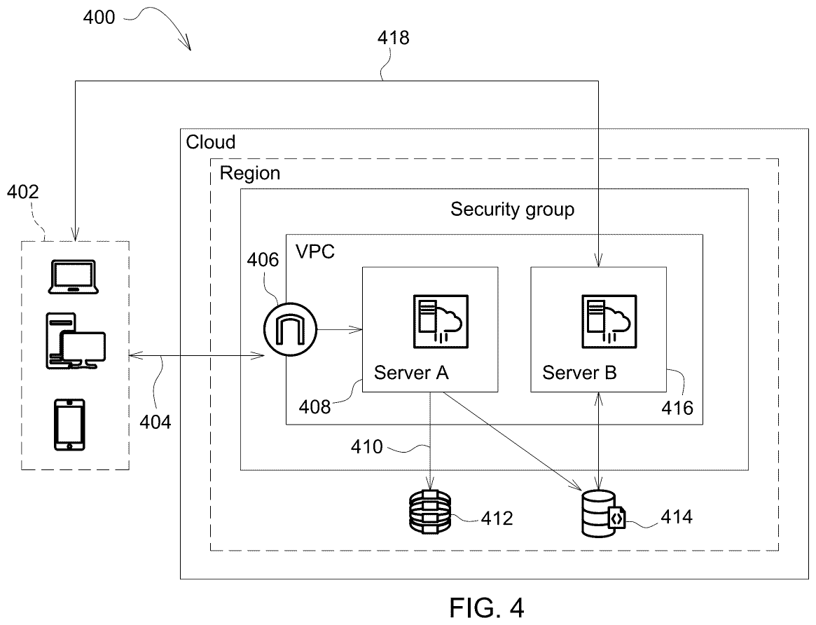

Referring next to FIG. 4, a method 400 may next be described for updating and storing documents, for example in the context of a collaborative document editing platform. The methods 200, 300, 400 disclosed herein may be completely separate, or in some embodiments two or more of the methods may be performed together and with respect to the same client-server system 100. Depending on the embodiment, certain acts, events, or functions of any of the steps described herein with respect to the method 400 can be performed in a different sequence, can be added, merged, or left out altogether.

The illustrated method 400 begins at 402 with an update made to a document by a user, for example via a client device, wherein a version is generated and transmitted via gateway 406 to a server 408 (Server A) within the cloud computing environment. Each update made to the document is further saved 410 in data storage 412, for example a managed database service such as DynamoDB. This ensures a persistent record of all changes.

With each new update from the client, a new representation (e.g., Ydoc) is initialized, incorporating all existing updates 410 from the data storage 412, e.g., DynamoDB, into the representation. This ensures that the new representation reflects the current state of the document with all historical changes applied.

Once the new representation (e.g., Ydoc) is fully initialized with all existing updates, the corresponding data may be converted into a structured format that represents the content and layout of the document. This structured format may be referred to as the plate document, which is then saved to, and stored in, a document database 414, e.g., DocumentDB.

When requested, such as for example via a web service call, a web server 416 is provided which retrieves all document versions from the storage system including the document database 414 and provides them through its endpoints 418. One example for the web server 416 may be a Representational State Transfer (REST) server having an architecture which facilitates the retrieval of all document versions, ensuring easy access for users and applications.

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” as used herein does not necessarily refer to the same embodiment, although it may. As used herein, the phrase “one or more of,” when used with a list of items, means that different combinations of one or more of the items may be used and only one of each item in the list may be needed. For example, “one or more of” item A, item B, and item C may include, for example, without limitation, item A or item A and item B. This example also may include item A, item B, and item C, or item B and item C.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The steps of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable medium known in the art. An exemplary computer-readable medium can be coupled to the processor such that the processor can read information from, and write information to, the memory/storage medium. In the alternative, the medium can be integral to the processor. The processor and the medium can reside in an ASIC. The ASIC can reside in a user terminal. In the alternative, the processor and the medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The term “communications network” as used herein with respect to data communication between two or more parties or otherwise between communications network interfaces associated with two or more parties may refer to any one of, or a combination of any two or more of, telecommunications networks (whether wired, wireless, cellular or the like), a global network such as the Internet, local networks, network links, Internet Service Providers (ISP's), and intermediate communication interfaces.

The previous detailed description has been provided for the purposes of illustration and description. Thus, although there have been described particular embodiments of a new and useful invention, it is not intended that such references be construed as limitations upon the scope of this invention except as set forth in the following claims.

What is claimed is:

1. A computer-implemented method for synchronizing replicas of collaborative data entities across a plurality of computing devices, wherein each replica comprises shared content having a plurality of sections in a defined arrangement, the method comprising
generating, for each of the plurality of sections, a corresponding representation of the respective content including any edits thereto; and
for each of the corresponding representations:
encoding an entire first state of the representation for a first computing device of the plurality of computing devices;
transmitting the encoded state of the representation for the first computing device from the first computing device to a second computing device via a first web service call;
at the second computing device, calculating a first state vector from the encoded first state, and calculating a second state vector corresponding to a second state of the representation for the second computing device;
determining, at the second computing device, any missing updates with respect to the first computing device and/or the second computing device based on at least the calculated first and second state vectors, and applying any relevant updates to the representation for the second computing device;
generating, in association with first web service call, from the second computing device to the first computing device any relevant updates with respect to the first computing device, wherein the any relevant updates with respect to the first computing device are applied to the representation for the first computing device.

2. The method of claim 1, wherein the web service call is performed using the Hypertext Transfer Protocol (HTTP).

3. The method of claim 1, wherein each representation comprises a respective conflict-free replicated data type (CRDT) file.

4. The method of claim 1, wherein each of the plurality of sections corresponds to a chapter in a defined book arrangement.

5. The method of claim 4, further comprising, in association with a requested import or export event, concurrent synchronization of each chapter in the defined book arrangement.

6. The method of claim 1, comprising:
generating a first hash digest of the representation for the first computing device; and
upon applying the any relevant updates to the representation for the second computing device, generating a second hash digest of the representation for the second computing device, and transmitting the second hash digest to the first computing device as part of the response to the web service call.

7. The method of claim 6, comprising:
comparing at the first computing device the first hash digest and the second hash digest; and
upon determining that the first hash digest and the second hash digest are not synchronized, applying the any relevant updates with respect to the first computing device.

8. The method of claim 1, wherein the first computing device is a client and the second computing device is a server.

9. The method of claim 8, wherein the server independently carries out associated steps in the method with respect to web service calls to and from each of a plurality of first computing devices.

10. A system for synchronizing replicas of collaborative data entities across a plurality of client computing devices, wherein each replica comprises shared content having a plurality of sections in a defined arrangement, the system comprising:
a central computing device functionally linkable to each of the plurality of client computing devices via a communications network;
wherein each of the client computing devices is configured to:
generate, for each of the plurality of sections, a corresponding representation of the respective content including any edits thereto; and
for each of the corresponding representations, encode an entire first state of the representation for the respective client computing device and further transmit the encoded state of the representation for the respective client computing device to the central computing device via a first web service call;
wherein the central computing device is configured, for each of the corresponding representations, to:
calculate a first state vector from the encoded first state;
calculate a second state vector corresponding to a second state of the representation for the central computing device;
determine any missing updates with respect to the respective client computing device and/or the central computing device based on at least the calculated first and second state vectors;
apply any relevant updates to the representation for the central computing device; and
generate, in association with the web service call, any relevant updates to the respective client computing device;
wherein the respective client computing device is further configured to apply the any relevant updates for the respective client computing device to the corresponding representation for the respective client computing device.

11. The system of claim 10, wherein the web service call is performed using the Hypertext Transfer Protocol (HTTP).

12. The system of claim 10, wherein each representation comprises a respective conflict-free replicated data type (CRDT) file.

13. The system of claim 10, wherein each of the plurality of sections corresponds to a chapter in a defined book arrangement.

14. The system of claim 13, wherein concurrent synchronization of each chapter in the defined book arrangement is programmatically executed in association with a requested import or export event.

15. The system of claim 10, wherein, for each of the corresponding representations:
the respective client computing device is configured to generate a first hash digest of the representation for the respective client computing device; and
the central computing device is configured, upon applying the any relevant updates to the representation for the central computing device, to generate a second hash digest of the representation for the central computing device, and transmit the second hash digest to the respective client computing device in association with the first web service call.

16. The system of claim 15, wherein the respective client computing device is further configured to compare the first hash digest and the second hash digest, and upon determining that the first hash digest and the second hash digest are not synchronized, to apply the any relevant updates.
